(19) United States
(12) Patent Application Publication
(10) Pub. No.: US 2014/0185298 A1
(43) Pub. Date: Jul. 3, 2014

(54) STROBE DEVICE

(71) Applicant: PANASONIC CORPORATION, Kodoma-shi, Osaka (JP)

(72) Inventors: Takao Kondo, Osaka (JP); Koji Takasaki, Kyoto (JP); Toshinori Maki, Shiga (JP); Toshiaki Murai, Osaka (JP)

(73) Assignee: PANASONIC CORPORATION, Osaka (JP)

(21) Appl. No.: 14/235,503

(22) PCT Filed: Aug. 6, 2012
(86) PCT No.: PCT/JP2012/004974

§ 371 Date: Jan. 28, 2014

(30) Foreign Application Priority Data
Aug. 8, 2011 (JP) 2011-172780

(51) Int. Cl. F21V 23/02; G03B 15/02; F21V 7/00

(52) U.S. Cl. CPC F21V 23/02; F21V 7/005; G03B 15/02
USPC 362/265

(57) ABSTRACT

A strobe device having small variations in the amount of light includes the following components: a flash discharge tube having an anode on one side and a cathode on the other side, the cathode having a metal sintered body at an end thereof; a conductive reflector composing an external trigger electrode, and storing a part of the flash discharge tube; and a trigger coil having a primary winding and a secondary winding around a hollow core. A portion of the cathode of the flash discharge tube not including the metal sintered body is inserted into the core of the trigger coil. The reflector, which is connected to the secondary winding of the trigger coil, has a bottom in contact with the outer peripheral surface of the flash discharge tube in such a manner as to cover at least the region extending from the anode to the cathode and the metal sintered body.

This application is a U.S. National Phase Application of PCT International Application PCT/JP2012/004974.

### TECHNICAL FIELD

The present invention relates to a strobe device used for taking pictures or other purposes.

### BACKGROUND ART

Conventional well-known strobe devices include the following components: a flash discharge tube having an anode on one side and a cathode on the other side which includes a metal sintered body at an end thereof; a reflector storing a part of the flash discharge tube; and a trigger coil having a cylindrical core and primary winding and secondary winding wound around the core.

In the above strobe devices, the flash discharge tube has a conductive thin-film transparent electrode formed on its surface, and the secondary winding of the trigger coil is connected to the thin-film transparent electrode of the flash discharge tube. This configuration allows the thin-film transparent electrode to function as an external trigger electrode, thereby illuminating the flash discharge tube.

In the above strobe devices, it is general that the trigger coil is solder-connected at its secondary output (secondary winding) to the thin-film transparent electrode as the external trigger electrode by a lead wire. The soldered part of the lead wire is subjected to a high voltage every time the flash discharge tube is illuminated. This causes the joint of the lead wire to develop heat and degrade due to the resistance component of the joint. Another problem is that the trigger coil generally has a large volume, which prevents the strobe devices from being compact.

To solve these problems, the following strobe device has been suggested (see, for example, Patent Literature 1) in which the trigger coil is disposed at an end of the flash discharge tube so that the thin-film transparent electrode on the surface of the flash discharge tube can be directly connected to the secondary output (secondary winding) of the trigger coil. This configuration is stated to reduce the degradation of the joint of the lead wire, thereby providing a compact strobe device.

In the strobe device of Patent Literature 1, however, the thin-film transparent electrode formed on the surface of the flash discharge tube undesirably absorbs the light emitted from the flash discharge tube. This causes a decrease in the amount of light emitted from the flash discharge tube or causes variations in the amount of light depending on the discharge location.

### CITATION LIST

### Patent Literature

Patent Literature 1: Japanese Patent No. 3710794

### SUMMARY OF THE INVENTION

The present invention is directed to provide a strobe device including a flash discharge tube having an anode on one side thereof and a cathode on the other side thereof, the cathode having a metal sintered body at an end thereof; a conductive reflector composing an external trigger electrode, and storing a part of the flash discharge tube; and a trigger coil having a primary winding and a secondary winding wound around a hollow core. The cathode of the flash discharge tube is inserted, at a portion not including the metal sintered body, into the core of the trigger coil. The reflector is connected to the secondary winding of the trigger coil, and has a bottom in contact with the outer peripheral surface of the flash discharge tube in such a manner as to cover at least the region extending from the anode to the cathode and the metal sintered body.

This configuration allows the strobe device to be more compact and thinner than the configuration in which the trigger coil is spaced from the flash discharge tube. Also, this configuration allows the discharge path of electrons emitted from the cathode to be formed stably from the vicinity of the cathode. This reduces variations in the amount of light emitted from the flash discharge tube, thereby irradiating the subject in a stable manner.

### BRIEF DESCRIPTION OF DRAWINGS

FIG. 1 is a perspective view of a strobe device according to an exemplary embodiment of the present invention.

FIG. 2 is a sectional view of the strobe device according to the exemplary embodiment taken along line 2-2 of FIG. 1.

FIG. 3 is an exploded perspective view of the strobe device according to the exemplary embodiment.

FIG. 4 is an exploded perspective view of an essential part of the strobe device according to the exemplary embodiment.

FIG. 5A is a perspective view of the essential part of the strobe device according to the exemplary embodiment.

FIG. 5B is a front view of the essential part of the strobe device according to the exemplary embodiment.

FIG. 6A is a front view showing the arrangement of a flash discharge tube and a reflector of the strobe device according to the exemplary embodiment.

FIG. 6B is a perspective view showing the arrangement of the flash discharge tube and the reflector of the strobe device according to the exemplary embodiment.

FIG. 7A is a perspective view of a trigger coil of the strobe device according to the exemplary embodiment.

FIG. 7B is a perspective view of the trigger coil of the strobe device according to the exemplary embodiment viewed in a different direction.

### DESCRIPTION OF EMBODIMENT

A strobe device according to an exemplary embodiment of the present invention will now be described with reference to drawings. Note that the present invention is not limited to the following exemplary embodiment.

### Exemplary Embodiment

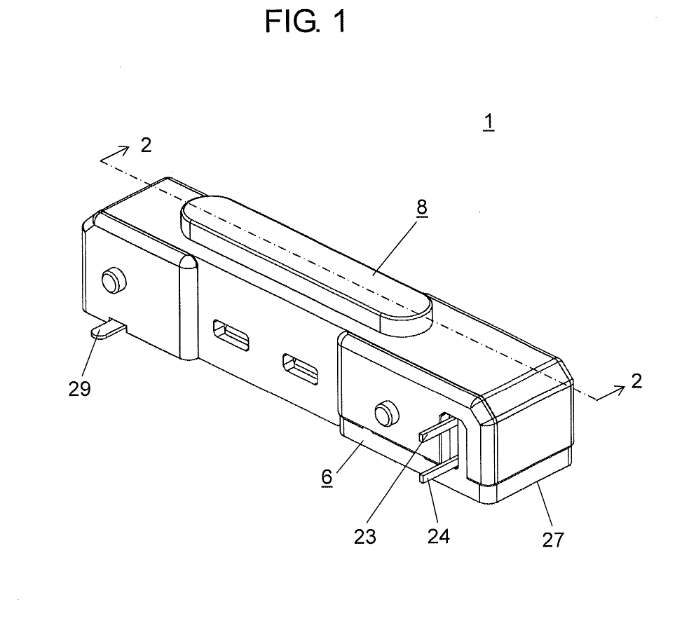

The strobe device according to the exemplary embodiment of the present invention will now be described with reference to FIGS. 1 to 7B.

First, the schematic configuration of the strobe device of the exemplary embodiment of the present invention will be described with reference to FIGS. 1 to 3.

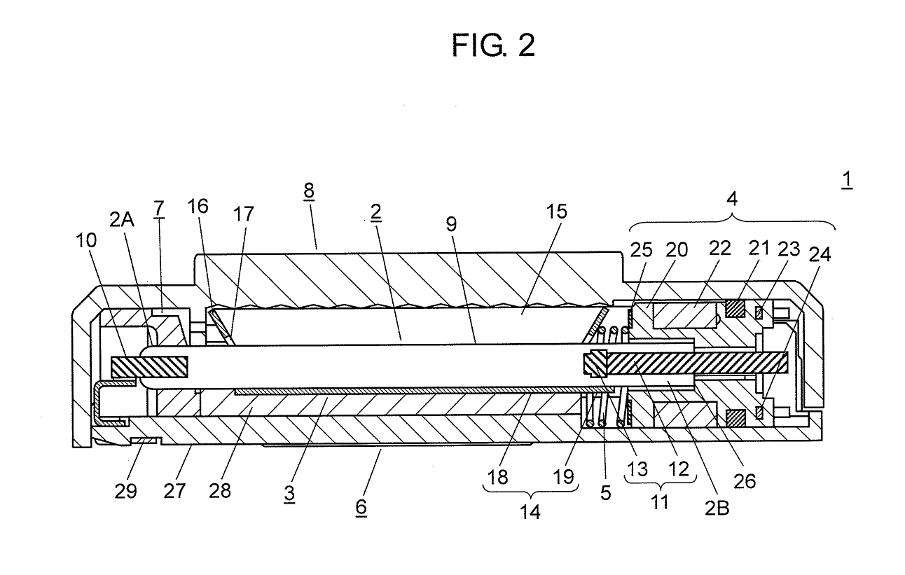

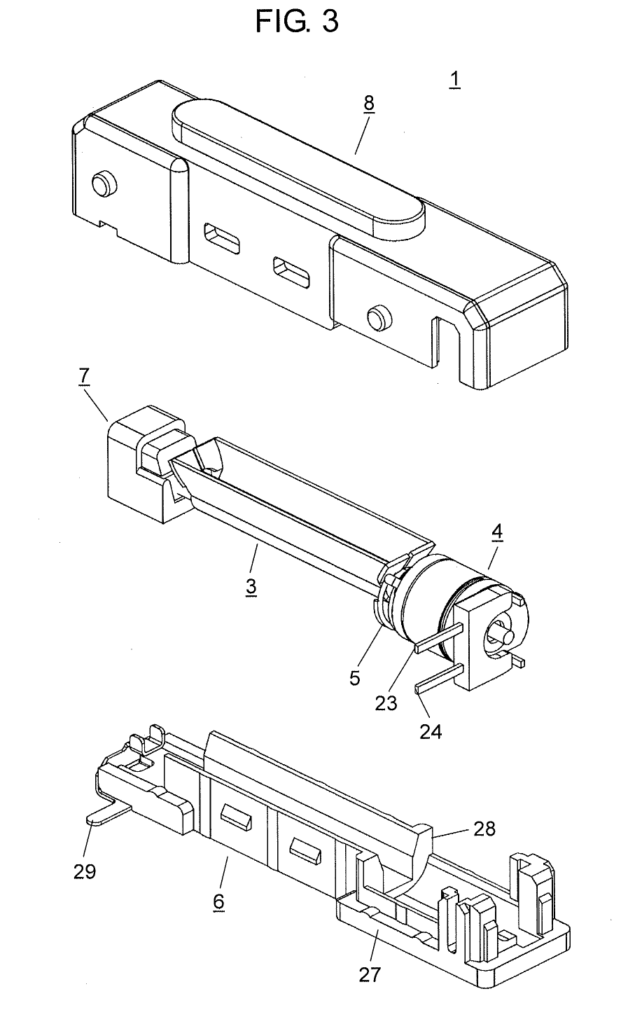

FIG. 1 is a perspective view of the strobe device according to the exemplary embodiment. FIG. 2 is a sectional view of the strobe device according to the exemplary embodiment taken along line 2-2 of FIG. 1. FIG. 3 is an exploded perspective view of the strobe device according to the exemplary embodiment.

As shown in FIG. 1, strobe device 1 of the exemplary embodiment includes base 6 which has body 27 including anode terminal 29, and optical panel 8 engaged with body 27. Strobe device 1 further includes primary terminal 23 and common terminal 24 of a trigger coil (not shown), and anode terminal 29, all of which are external terminals projecting outside strobe device 1.

As shown in FIGS. 2 and 3, strobe device 1 of the exemplary embodiment stores at least flash discharge tube 2 for emitting light, conductive reflector 3, trigger coil 4, conductor 5, and bushing 7. Reflector 3 stores a part of flash discharge tube 2, thereby functioning as an external trigger electrode of flash discharge tube 2. Trigger coil 4 is disposed on other side 2B of flash discharge tube 2 in such a manner that primary terminal 23 and common terminal 24 project outside strobe device 1. Conductor 5 electrically connects reflector 3 and trigger coil 4. Bushing 7 fixes an end (the anode side) of flash discharge tube 2 to base 6.

As shown in FIG. 3, base 6 includes body 27 made of an insulating material such as polycarbonate, elastic body 28 disposed inside body 27 which stores reflector 3, and plate-shaped anode terminal 29 which is connected to the anode of flash discharge tube 2 via bushing 7 and is projecting as an external terminal. Elastic body 28 is in contact with the outer periphery of bottom 14 of reflector 3. Elastic body 28 elastically deforms so that body 27 and optical panel 8 made of a light transmitting material such as PMMA can be engaged with each other, allowing base 6 to hold reflector 3 sandwiched between body 27 and optical panel 8.

As shown in FIG. 2, flash discharge tube 2 includes tubular glass bulb 9, anode 10 disposed on one side 2A, and cathode 11 disposed on other side 2B. Glass bulb 9 is filled with a rare gas such as xenon at a predetermined pressure. When electrons collide with the rare gas, flash discharge tube 2 generates and emits light to illuminate a subject. Anode 10 is a bar-shaped electrode made, for example, of tungsten. Anode 10 is inserted into glass bulb 9 and fixed at one side 2A of glass bulb 9 by being melted with glass beads (not shown). Cathode 11 is formed of bar-shaped electrode 12 and metal sintered body 13. Bar-shaped electrode 12 is made, for example, of tungsten, and is inserted into glass bulb 9 and fixed at other side 2B of glass bulb 9 by being melted with glass beads (not shown). Metal sintered body 13 is made of a mixture of metal fine powder, such as a mixture of tungsten and tantalum or a mixture of tantalum and nickel. Metal sintered body 13 is fixed to bar-shaped electrode 12 at the end inside glass bulb 9 of cathode 11.

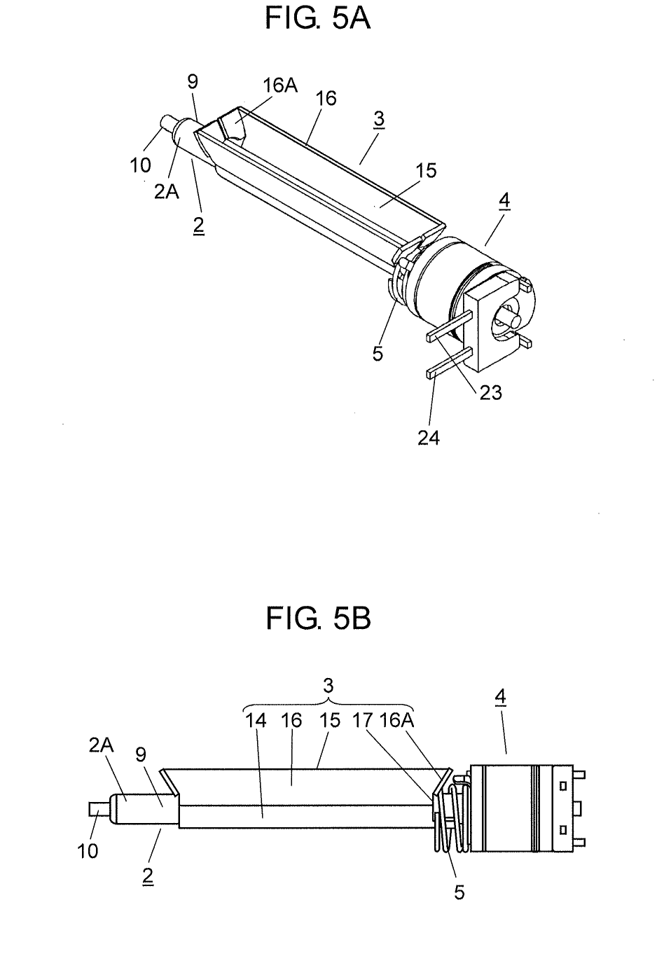

The following is a detailed description, with reference to FIGS. 5A to 7B, of the configuration of reflector 3 and trigger coil 4 of strobe device 1 according to the exemplary embodiment.

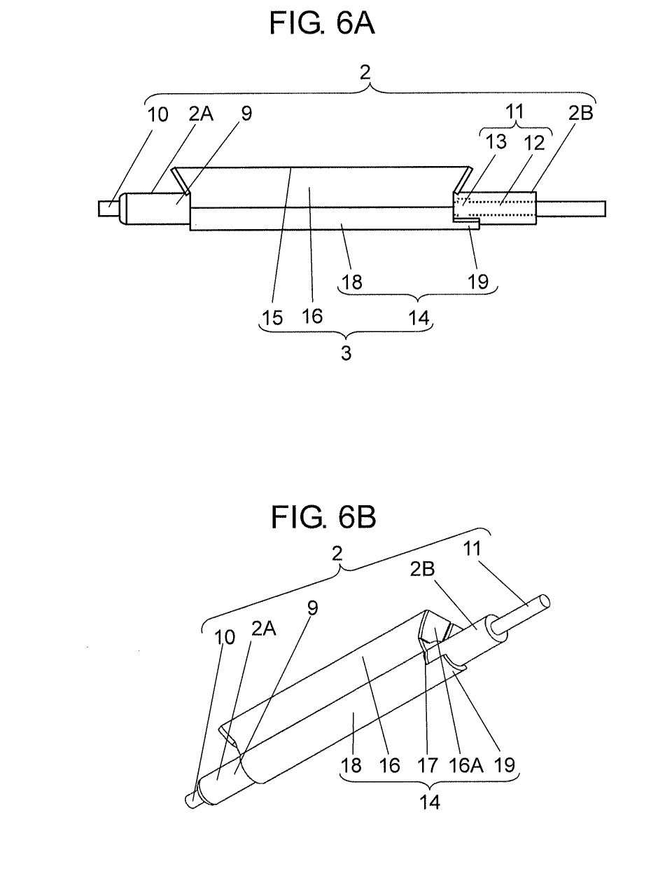

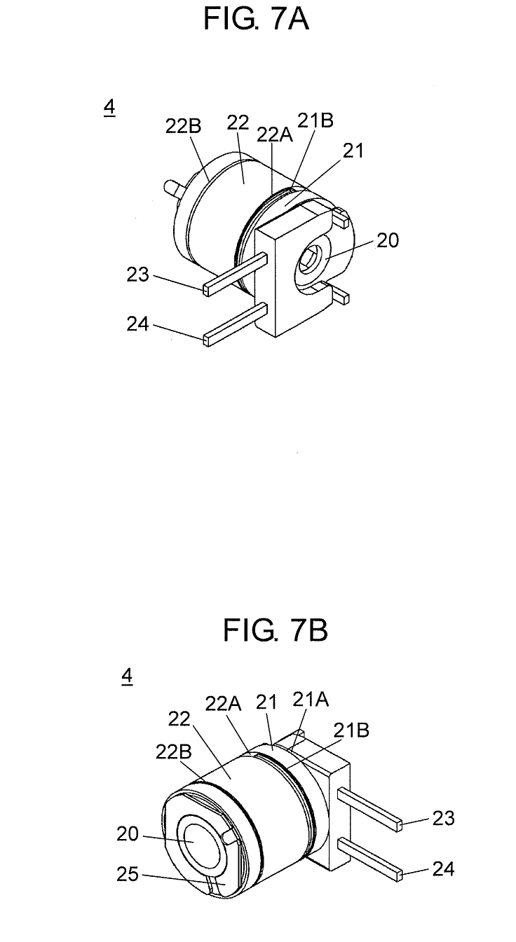

FIG. 5A is a perspective view of the essential part of the strobe device according to the exemplary embodiment. FIG. 5B is a front view of the essential part of the strobe device according to the exemplary embodiment. FIGS. 6A and 6B are a front view and a perspective view, respectively, showing the arrangement of the flash discharge tube and the reflector of the strobe device according to the exemplary embodiment. FIGS. 7A and 7B are perspective views of the trigger coil of the strobe device viewed in different directions from each other according to the exemplary embodiment.

As shown in FIGS. 5A to 6B, reflector 3 has bottom 14, opening 15, side reflective portion 16, and installation hole 17. Bottom 14 of reflector 3 is configured to be in contact with the outer peripheral surface of flash discharge tube 2. This allows reflector 3 to function as an external trigger electrode of flash discharge tube 2. Opening 15 passes the light emitted from flash discharge tube 2 to the outside. Side reflective portion 16 reflects the light emitted from flash discharge tube 2 toward opening 15. Side reflective portion 16 extends in the axial (longitudinal) direction of flash discharge tube 2, and has end-face reflective portion 16A. End-face reflective portion 16A is formed by bending both ends of side reflective portion 16 of reflector 3 in the direction perpendicular to the axial (longitudinal) direction of flash discharge tube 2 and then by inclining and expanding the ends toward opening 15. Installation hole 17 allows passage of flash discharge tube 2, so that flash discharge tube 2 is stored in reflector 3.

Bottom 14 of reflector 3 is formed of base portion 18 and extension 19. Base portion 18 is configured to be in contact with the outer peripheral surface of flash discharge tube 2 so as to cover the region extending from anode 10 to cathode 11. Base portion 18 has a shape of an arc having substantially (or exactly) the same radius as glass bulb 9 so that base portion 18 can be in surface contact with the outer peripheral surface of glass bulb 9. This configuration allows base portion 18 to function as a reflective plate by which the light emitted from flash discharge tube 2 toward base portion 18 is reflected to opening 15 of reflector 3, and also as an external trigger electrode of flash discharge tube 2.

Extension 19 extends from base portion 18 of bottom 14 toward other side 2B of flash discharge tube 2 in the axial (longitudinal) direction so as to be in contact with the outer peripheral surface of flash discharge tube 2, thereby covering metal sintered body 13 of cathode 11. Extension 19 has a shape of an arc having substantially (or exactly) the same radius as glass bulb 9 so as to be in surface contact with the outer peripheral surface of glass bulb 9. This configuration allows extension 19 to function as an external trigger electrode of flash discharge tube 2 in the same manner as base portion 18.

As shown in FIGS. 7A and 7B, trigger coil 4 includes hollow cylindrical core 20, and primary winding 21 and secondary winding 22 wound around core 20. Core 20 is formed of a magnetic body such as ferrite. As shown in FIG. 2, primary winding 21 is on the other side (on the primary terminal 23 side) of core 20 of trigger coil 4, whereas secondary winding 22 is on one side of core 20 of trigger coil 4, that is, on the side adjacent to reflector 3 opposite to core 20. One end 22A of secondary winding 22 is connected to other end 21B of primary winding 21.

Trigger coil 4 further includes primary terminal 23 connected to one end 21A of primary winding 21; common terminal 24 connected to other end 21B of primary winding 21 and to one end 22A of secondary winding 22; and secondary terminal 25 connected to other end 22B of secondary winding 22. Common terminal 24 is electrically connected also to cathode 11 of flash discharge tube 2.

As best shown in FIGS. 1 and 7A, primary terminal 23 and common terminal 24 of trigger coil 4 are bar-shaped, projecting to the outside and are connected as external terminals to, for example, an external driving circuit (not shown). Secondary terminal 25, on the other hand, has an annular plate shape and is disposed at an end of trigger coil 4 (in the axial direction of core 20), that is, the end adjacent to reflector 3 as shown in FIG. 7B.

As shown in FIG. 2, hollow core 20 has locking member 26 for positioning flash discharge tube 2 in the axial (longitudinal) direction, Locking member 26 projects inside in the radial direction of core 20, thereby locking the end of flash discharge tube 2 on other side 2B. In core 20, the portion of bar-shaped electrode 12 of cathode 11 of other side 2B of flash discharge tube 2 leading up to metal sintered body 13 of cathode 11 which is melted after being inserted into glass bulb 9 is inserted until reaching locking member 26. As a result, the portion of cathode 11 not including metal sintered body 13 can be surely inserted into core 20 of trigger coil 4.

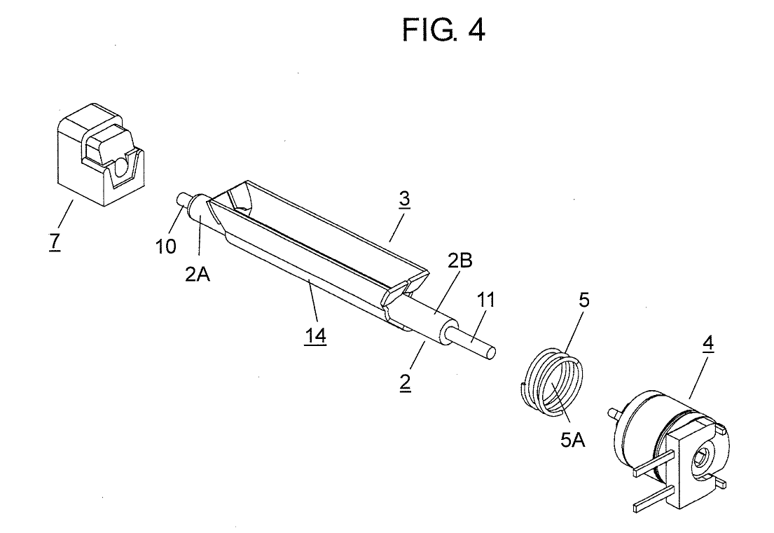

Next, the configuration of conductor 5 of strobe device 1 according to the exemplary embodiment will now be described in detail based on FIG. 4 with reference to FIGS. 2 and 5B.

FIG. 4 is an exploded perspective view of the essential part of the strobe device according to the exemplary embodiment.

As shown in FIG. 4, conductor 5 is made of a cylindrical elastically deformable conductive member such as a spring (coil spring), and has insertion portion 5A inside for passing flash discharge tube 2 therethrough.

As shown in FIG. 5B, conductor 5, which is compressed in the axial (longitudinal) direction of flash discharge tube 2, is sandwiched between secondary terminal 25 of trigger coil 4 and the outer surface of reflector 3 (for example, end-face reflective portion 16A and installation hole 17). This configuration establishes an electrical connection between secondary winding 22 of trigger coil 4 and reflector 3 via conductor 5.

As shown in FIG. 2, other side 2B of flash discharge tube 2 is inserted into trigger coil 4 through insertion portion 5A of conductor 5, and flash discharge tube 2 stored in reflector 3 is laid between body 27 of base 6 and optical panel 8 which are engaged with each other. As a result, elastic body 28 of base 6 elastically deforms. Because of the restoring force (biasing force) due to the elastic deformation of elastic body 28 of base 6, glass bulb 9 of flash discharge tube 2 can be in contact with bottom 14 of reflector 3, and flash discharge tube 2 and other components can be held in base 6 and optical panel 8. The strobe device of the exemplary embodiment is configured as described above.

The operation and action of strobe device 1 of the exemplary embodiment will now be described as follows.

First, a driving voltage is applied from an external driving circuit (not shown) to anode 10 and cathode 11 of flash discharge tube 2 via anode terminal 29 and common terminal 24, which are external terminals of strobe device 1.

At the same time as the application of the voltage or after a predetermined amount of time, a pulse-like voltage is applied from the external driving circuit (not shown) to primary winding 21 of trigger coil 4 via primary terminal 23 and common terminal 24, which are external terminals of strobe device 1. The voltage applied to primary winding 21 is, for example, boosted at secondary winding 22. The boosted voltage is applied as a trigger pulse to bottom 14 of reflector 3 from secondary terminal 25 of trigger coil 4 via conductor 5.

This activates and ionizes the rare gas filled in glass bulb 9 near the inner periphery of glass bulb 9 which is in contact with base portion 18 and extension 19 of bottom 14 of reflector 3.

Cathode 11 also emits electrons toward anode 10 so as to promote the ionization of the rare gas, making the rare gas more conductive. This causes a sudden large current flow from anode 10 to cathode 11, allowing flash discharge tube 2 to emit light to illuminate the outside.

At this moment, the trigger pulse is applied also to extension 19 of bottom 14 of reflector 3 covering metal sintered body 13 of cathode 11. The pulse application allows the stable formation of a discharge path of electrons emitted from the vicinity of cathode 11. This reduces variations in the amount of light emitted from flash discharge tube 2, thereby irradiating the subject in a stable manner.

The present invention is not limited to the above-described exemplary embodiment and can be properly changed within the range not deviating from the spirit of the present invention. It also goes without saying that the configuration and methods of the following various modified examples can be arbitrary selected and adopted into the above-described exemplary embodiment.

For example, flash discharge tube 2 has no thin-film transparent electrode on its surface in the exemplary embodiment, but may alternatively have a thin-film transparent electrode such as an ITO or NESA film formed thereon. In this case, the thin-film transparent electrode absorbs light as in the conventional strobe devices, but the configuration of the present invention allows the flash discharge tube to generate light at high efficiency, thereby reducing the influence of the light absorption. In this case, too, at least the region extending from anode 10 to cathode 11 of flash discharge tube 2, and metal sintered body 13 can be covered by bottom 14 of reflector 3, which is in contact with the outer peripheral surface of the glass bulb of flash discharge tube 2 having the thin-film transparent electrode formed thereon. This reduces variations in the amount of light emitted from flash discharge tube 2, thereby irradiating the subject in a stable manner.

Extension 19 of reflector 3 is arc-shaped in the exemplary embodiment, but may alternatively be, for example, flat-shaped. In this case, too, the discharge path of the electrons emitted from cathode 11 can be formed stably from the vicinity of cathode 11.

Conductor 5 is a spring in the exemplary embodiment, but may alternatively be, for example, a C-shaped plate spring or a disc spring connecting secondary terminal 25 of trigger coil 4 and reflector 3.

Reflector 3 has end-face reflective portion 16A in the exemplary embodiment, by may alternatively have side reflective portion 16 only. This simplifies the configuration of the reflector and facilitates the insertion of flash discharge tube 2, thereby providing high productivity.

As described hereinbefore, strobe device 1 of the present invention includes flash discharge tube 2 having anode 10 on one side 2A and cathode 11 on other side 2B, cathode 11 having metal sintered body 13 at an end thereof; conductive reflector 3 composing an external trigger electrode, and storing a part of flash discharge tube 2; and trigger coil 4 having primary winding 21 and secondary winding wound 22 around hollow core 20. Cathode 11 of flash discharge tube 2 is inserted, at a portion not including metal sintered body 13, into core 20 of trigger coil 4. Reflector 3 is connected to secondary winding 22 of trigger coil 4, and has bottom 14 in contact with the outer peripheral surface of flash discharge tube 2 in such a manner as to cover at least the region extending from anode 10 to cathode 11 and metal sintered body 13.

Conductive reflector 3 is in contact with the outer peripheral surface of flash discharge tube 2 and is electrically connected to secondary winding 22 of trigger coil 4. As a result, reflector 3 can function as an external trigger electrode of flash discharge tube 2.

When a voltage is applied between anode 10 and cathode 11 of flash discharge tube 2, and a trigger pulse is applied to bottom 14 of reflector 3, a uniform electron flow is generated between anode 10 and cathode 11 of flash discharge tube 2. In this case, bottom 14 of reflector 3 which is in contact with the outer peripheral surface of flash discharge tube 2 at least covers not only the region extending from anode 10 to cathode 11, but also metal sintered body 13 of cathode 11. In this case, the discharge path of the electrons emitted from cathode 11 can be formed stably from the vicinity of cathode 11. This reduces variations in the amount of light emitted from flash discharge tube 2, thereby irradiating the subject in a stable manner.

In the strobe device of the present invention, core 20 of trigger coil 4 includes locking member 26 projecting inside in the radial direction of core 20.

In this configuration, locking member 26 projecting inside in the radial direction of core 20 of trigger coil 4 locks the end of flash discharge tube 2 on either one side 2A or other side 2B. As a result, flash discharge tube 2 can be positioned relative to trigger coil 4 in the axial direction, thereby preventing metal sintered body 13 of cathode 11 of flash discharge tube 2 from being inserted into core 20 of trigger coil 4.

The strobe device of the present invention further includes conductor 5 connecting secondary winding 22 of trigger coil 4 and reflector 3, and secondary terminal 25 which is disposed at the end of trigger coil 4 adjacent to reflector 3 and is connected to secondary winding 22. Conductor 5 has insertion portion 5A into which flash discharge tube 2 is inserted, and is sandwiched between secondary terminal 25 of trigger coil 4 and reflector 3.

In the strobe device of the present invention, conductor 5 is made of an elastic material, and is compressed and sandwiched between the secondary terminal of the trigger coil and the reflector.

In the above configuration, trigger coil 4 includes secondary terminal 25, at other end 22B, which is electrically connected to secondary winding 22 of trigger coil 4. Conductor 5 has insertion portion 5A and is made of an elastic material. As a result, conductor 5 can be compressed in the axial direction of flash discharge tube 2 which passes through conductor 5 and be sandwiched between secondary terminal 25 of trigger coil 4 and reflector 3. This configuration establishes an electrical connection between secondary winding 22 of trigger coil 4 and reflector 3 via conductor 5. Consequently, strobe device 1 is reliable and has small variations in the amount of light.

Conductor 5 is electrically connected to trigger coil 4 and reflector 3 not by solder welding but by its biasing force. This simplifies the assembly (production process) of strobe device 1, thereby increasing productivity.

### INDUSTRIAL APPLICABILITY

The strobe device of the present invention, which emits a sufficient amount of light from the flash discharge tube, is useful for irradiating a subject to take pictures of.

### REFERENCER MARKS IN THE DRAWINGS

1 strobe device

2 flash discharge tube

2A one side

2B other side

3 reflector

4 trigger coil

5 conductor

5A insertion portion

6 base

7 bushing

8 optical panel

9 glass bulb

10 anode

11 cathode

12 bar-shaped electrode

13 metal sintered body

14 bottom

15 opening

16 side reflective portion
16A end-face reflective portion

17 installation hole

18 base portion

19 extension

20 core

21 primary winding

21A, 22A one end

21B, 22B other end

22 secondary winding

23 primary terminal

24 common terminal

25 secondary terminal

26 locking member

27 body

28 elastic body

29 anode terminal

1. A strobe device comprising:
a flash discharge tube having an anode on one side thereof and a cathode on an other side thereof, the cathode having a metal sintered body at an end thereof;
a conductive reflector composing an external trigger electrode, and storing a part of the flash discharge tube; and
a trigger coil having a primary winding and a secondary winding wound around a hollow core,
wherein
a portion of the cathode of the flash discharge tube not including the metal sintered body is inserted into the core of the trigger coil; and
the reflector is connected to the secondary winding of the trigger coil, and has a bottom in contact with an outer peripheral surface of the flash discharge tube in such a manner as to cover at least a region extending from the anode to the cathode and the metal sintered body.

2. The strobe device of claim 1, wherein the core of the trigger coil includes a locking member projecting inside in a radial direction of the core.

3. The strobe device of claim 1, further comprising:
a conductor connecting the secondary winding of the trigger coil and the reflector; and
a secondary terminal disposed at an end of the trigger coil and connected to the secondary winding, the end being adjacent to the reflector,
wherein the conductor has an insertion portion into which the flash discharge tube is inserted, the conductor being sandwiched between the secondary terminal of the trigger coil and the reflector.

4. The strobe device of claim 3, wherein the conductor is made of an elastic material, and is compressed and sandwiched between the secondary terminal of the trigger coil and the reflector.
